(19) United States
(12) Patent Application Publication
(10) Pub. No.: US 2020/0246209 A1
(43) Pub. Date: Aug. 6, 2020

(54) APPARATUS FOR REHABILITATION OF THE UPPER LIMBS OF A PERSON

(71) Applicant: S.M. SCIENZIA MACHINALE S.R.L., Cascina (PI) (IT)

(72) Inventors: Luca BOSIO, Pisa (IT); Gianluca PARRINI, Cascina (PI) (IT); Renzo VALLEGGI, Cascina (PI) (IT); Luca FERRETTI, Pisa (IT); Luca LIVALDI, Cascina (PI) (IT); Alessandro MARCHINI, Cascina (PI) (IT)

(73) Assignee: S.M. SCIENZIA MACHINALE S.R.L., Cascina (PI) (IT)

(21) Appl. No.: 16/639,340

(22) PCT Filed: Aug. 13, 2018
(86) PCT No.: PCT/IB2018/056089

§ 371 Date: Feb. 14, 2020

(30) Foreign Application Priority Data
Aug. 22, 2017 (IT) 102017000094995
Aug. 22, 2017 (IT) 102017000095005
Aug. 22, 2017 (IT) 102017000095013

(51) Int. Cl. A61H 1/02

(52) U.S. Cl. CPC A61H 1/0281; A61H 2201/5069; A61H 2201/1638; A61H 2201/018

(57) ABSTRACT

Apparatus (1) for rehabilitation of an upper limb of a person comprising a base frame (10) and a kinematic chain (100) connected to each other. The kinematic chain (100) comprises a plurality of rigid links (21-25) connected in series one after the other through a plurality of rotational joints (31-34), each of which having a respective rotation axis (131-134) and arranged to rotatably connect two successive rigid links of the series. The apparatus (1) comprises a plurality of actuation groups (70), each of which associated to a respective rotational joint and configured to generate and transmit a predetermined driving power to the rotational joint associated to it. The series of rigid links (21-25) comprises a first rigid link (21) operatively connected to the base frame (10) through a connection device (50) configured to move from a connection configuration, in which the first rigid link (21) is integral to the base frame (10), to a release configuration, in which the first rigid link (21) is free to rotate with respect to the base frame (10).

### FIELD OF THE INVENTION

The present invention relates to the technical field of the apparatuses for rehabilitation of the upper limbs of a patient with reduced mobility capacities.

In particular, the present invention refers to an apparatus for rehabilitation of the upper limbs that is able to guarantee suitable safety conditions for the user during the rehabilitation treatment.

### DESCRIPTION OF THE PRIOR ART

As it is known, different types of apparatus exist that are used for the rehabilitation of the upper, or the lower limbs, of patients, who, due to traumas, accidents, or cerebrovascular attacks, or ictus, can manifest a complete, or a partial, loss of their mobility capacities.

Usually an apparatus for rehabilitation of the upper limbs provides a fixed frame fixed to a kinematic chain comprising a determined number of rigid links that are rotatably connected in series by motorized rotational joints. These are operated by motors in order to rotate about respective rotation axes and to exert determined forces on the structure. In a rehabilitation session, the patient grasps the kinematic chain at a handle portion in such a way that it is possible to transmit determined forces to the patient, who in turn exerts forces on the apparatus structure.

According to the responses obtained by subjecting the injured limbs of the user to determined exercises, it is possible to decide which is the best rehabilitation programme in order to gradually and progressively recover, at least in part, the normal motor abilities.

However, the apparatuses for rehabilitation of known type have many drawbacks.

Firstly, since the kinematic chain is rigidly connected to the fixed frame, if, owing to a muscular spasm, i.e. a sudden and involuntary contraction of the muscles, as it frequently happens in patients affected by ictus, the structure of the apparatus impedes, or at least strongly hampers, the movement of the user. This can have serious consequences on the user's health, causing muscular lesions, such as contractures, strains, even bone fractures, and make the already critical health condition considerably worse.

Examples of apparatuses for rehabilitation having the above mentioned drawbacks are described in WO2015/099858, U.S. Pat. No. 7,862,524 and US2011/251533.

### SUMMARY OF THE INVENTION

It is therefore an object of the present invention to provide an apparatus that is able to overcome the above mentioned drawbacks of the apparatuses of known type for rehabilitation of the upper limbs of a person.

These and other objects are achieved by the apparatus, according to the invention, for rehabilitation of an upper limb of a person that comprises:
a base frame;
a kinematic chain operatively connected a said base frame, said kinematic chain comprising:
   a plurality of rigid links connected in series one after the other between a first rigid link and a last rigid link, said first rigid link being operatively connected to said base frame;
   a plurality of rotational joints each of which having a respective rotation axis and arranged to rotatably connect two successive rigid links of said series;
   said kinematic chain being configured in such a way that the rotation axes of the first 3 rotational joints, starting from said first rigid link, are arranged to intersect each other in a point C positioned, in use, at the centre C′ of the shoulder articulation of the user;
a plurality of actuation groups, each actuation group of said plurality being associated to a respective rotational joint and being configured to generate and transmit a predetermined driving power to said rotational joint associated to it;
a detection group configured to determine the angular position of each rotational joint of said plurality;
a fastening device configured to engage the user's arm to at least a rigid link of said plurality;

whose main characteristic is that the first rigid link is operatively connected to said base frame by means of a connection device configured to move from a connection configuration, in which is arranged to transmit a torque between said first rigid link and said base frame, to a release configuration, in which said first rigid link is free to rotate with respect to said base frame, whereby no torque transmission can be carried out between said first rigid link and said base frame, when the user exerts, at the above disclosed fastening device, a force such that the connection device is subjected to a torque higher than a predetermined threshold value.

Other features of the invention and the relative embodiments are defined in the dependent claims.

In particular, the connection device can comprise a first portion integral to the base frame and a second portion integral to the first rigid link, said first and said second portion being configured to rotate one respect to the other, when said second portion is subjected to a torque higher than said predetermined threshold value.

More in particular, the connection device can provide:
an electromagnet configured to exert a predetermined magnetic attraction force between said first and said second portion of said connection device when is supplied with a predetermined direct current and/or voltage, said predetermined magnetic attraction force being correlated to said predetermined threshold value;
at least an antagonist member configured to exert a predetermined antagonist force opposing the magnetic attraction force and arranged to move the first portion and the second portion of the connection device away one from each other.

For example, the, or each antagonist member can be an elastic member.

Advantageously, the connection device comprises, furthermore, at least a presence sensor configured to detect the relative rotation between the first and the second portion of the connection device and to send a corresponding control signal to a control unit, said control unit arranged to interrupt the direct current and/or voltage supply to the electromagnet when receives the above mentioned control signal.

In particular, the first and the second portion can provide respective high friction surfaces facing each other. Advantageously, in the above mentioned connection configuration of the connection device the surfaces facing each other are positioned adjacent one another.

In an advantageous embodiment, the above disclosed surfaces facing each other provide respective pluralities of teeth arranged to engage with each other to mutually engage the first and the second portion of the connection device.

Preferably, the connection device is associated to an adjustment device configured to adjust the magnetic attraction force exerted by the electromagnet between the first and the second portion, in such a way to adjust the predetermined threshold value.

Preferably, the fastening device is configured to move from an engagement configuration, in which is arranged to fasten the user's arm to said, or each, rigid link of said plurality, to a disengagement configuration, in which said fastening device is arranged to disengage the user's arm from said, or each, rigid link of said plurality, when the force applied by the user at said fastening device is greater than predetermined force threshold value.

In a preferred embodiment, the fastening device comprises:
at least a housing portion, in particular substantially cradle-shaped, configured to house, in use, the user's forearm;
a fastening portion fixed to said, or each, rigid link;

and wherein said fastening device is, furthermore, associated to a safety device configured to mutually engage, in a removable way, said housing portion and said fastening portion.

Advantageously, the above disclosed safety device is associated to a set device configured to set said predetermined force threshold value.

In particular, the above mentioned safety device can comprise at least a magnet integral to the housing portion, or to the fastening portion. More in particular, the, or each, magnet is configured to exert a predetermined magnetic force on a respective portion made of ferromagnetic material integral, respectively, to the fastening portion, or to the housing portion.

Advantageously, the adjustment device is configured to increase, or decrease, the entrefer, that is the distance between said portion made of ferromagnetic material and said, or each, magnet.

In particular, the base frame and the kinematic chain are configured in such a way that the rotation axis of the first rotational joint of the kinematic chain is inclined by a predetermined angle α with respect to a vertical direction, in such a way to simplify the positioning of the centre C′ of the shoulder articulation of the user at the intersection point C of said first 3 rotation axes. For example, the predetermined angle α can be set between 5° and 30°.

According to another aspect of the invention, an apparatus for rehabilitation of an upper limb of a person comprises:
a base frame;
a kinematic chain connected to the base frame, said kinematic chain comprising:
   a plurality of rigid links connected in series one after the other;
   a plurality of rotational joints each of which having a respective rotation axis and arranged to rotatably connect two successive rigid links of said series;

said kinematic chain being configured in such a way that the rotation axes of the first 3 rotational joints are arranged to intersect each other in a point C positioned, in use, at the centre C′ of the shoulder articulation of the user;
a plurality of actuation groups, each actuation group of said plurality associated to a respective rotational joint and being configured to generate and transmit a predetermined driving power to said rotational joint associated to it;
a detection group configured to determine the angular position of each rotational joint of said plurality;
a fastening device configured to fasten the user's arm to at least a rigid link of said plurality;

whose main characteristic is that said base frame and said kinematic chain are configured in such a way that the rotation axis of the first rotational joint of said kinematic chain is inclined by a predetermined angle a with a vertical direction, in such a way to simplify the positioning of the centre C′ of the shoulder articulation of the user at said intersection point C of said first 3 rotation axes.

According to a further aspect of the invention, an apparatus for rehabilitation of an upper limb of a person comprises:
a base frame;
a kinematic chain connected to said base frame, said kinematic chain comprising:
   a plurality of rigid links connected in series one after the other between a first rigid link and a ultimo rigid link, said first rigid link being operatively connected to said base frame;
   a plurality of rotational joints each of which having a respective rotation axis and arranged to rotatably connect two successive rigid links of said series;

said kinematic chain being configured in such a way that the rotation axes of the first 3 rotational joints, starting from said first rigid link, are arranged to intersect each other in a point C positioned, in use, at the centre C′ of the shoulder articulation of the user;
a plurality of actuation groups, each actuation group of said plurality being associated to a respective rotational joint being configured to generate and transmit a predetermined driving power a said rotational joint associated to it;
a detection group configured to determine the angular position of each rotational joint of said plurality;
a fastening device configured to fasten the user's arm to at least a rigid link of said plurality;

whose main characteristic is that the fastening device is configured to move from an engagement configuration, in which is arranged to engage the user's arm to said, or each, rigid link of said plurality, to a disengagement configuration, in which said user's arm is disengaged from said, or each, rigid link of said plurality, when the force applied by the user at said fastening device is greater than a predetermined force threshold value.

### BRIEF DESCRIPTION OF THE DRAWINGS

The invention will now be shown with the following description of its exemplary embodiments, exemplifying but not limitative, with reference to the attached drawings in which:

FIG. 1 diagrammatically shows a perspective side elevation view of a first embodiment of the apparatus, according to the invention, for rehabilitation of the upper limbs of a patient, in a first working configuration;

FIG. 2 diagrammatically shows a possible embodiment of the connection device of which the apparatus of FIG. 1 is equipped with, in a connection configuration;

FIG. 3 diagrammatically shows a possible embodiment of the actuation and of the detection group of the angular position of the rotational joints of which the apparatus, according to the invention, is provided of;

FIG. 4 diagrammatically shows a perspective side elevation view of the apparatus of FIG. 1 in a second working configuration;

FIG. 5 diagrammatically shows the connection device of FIG. 2, in a release configuration;

FIG. 6 diagrammatically shows in detail, a possible embodiment of the fastening device of the user's arm to at least a rigid link of the apparatus of FIG. 1, in an engagement configuration;

FIG. 7A diagrammatically shows the fastening device of FIG. 6, in a disengagement configuration;

FIG. 7B diagrammatically shows a front view of a possible embodiment of the magnets that carry out the engagement of the housing portion to the kinematic chain of the apparatus of FIG. 1;

FIG. 8 diagrammatically shows a perspective side elevation view of the apparatus of FIG. 1 in working conditions;

FIG. 9 diagrammatically shows a perspective side elevation view of a possible alternative embodiment of the apparatus of FIG. 1;

FIG. 10 diagrammatically shows a perspective side elevation view of another possible alternative embodiment of the apparatus of FIG. 1;

FIG. 11 diagrammatically shows perspective side elevation view of a further alternative embodiment of the apparatus of FIG. 1.

### DETAILED DESCRIPTION OF SOME EXEMPLARY EMBODIMENTS OF THE INVENTION

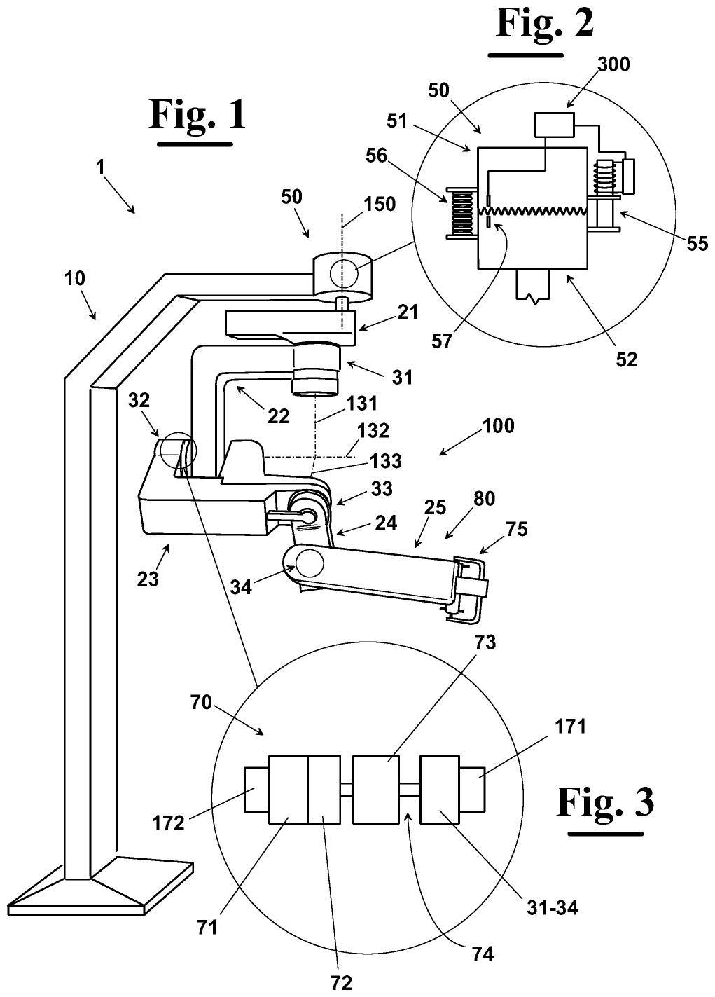

As diagrammatically shown in FIG. 1, an apparatus 1 for rehabilitation of an upper limb of a person comprises a base frame 10 and a kinematic chain 100 operatively connected to the base frame 10 and comprising a determined number of rigid links, for example 5 rigid links 21-25, connected in series one after the other between a first rigid link 21 operatively connected to the base frame 10, and a last rigid link 25. A determined number of rotational joints, for example 4 rotational joints 31-34, is then provided, each of which having a respective rotation axis 131-134, and arranged to rotatably connect two successive rigid links of the series. In particular, kinematic chain 100 is configured in such a way that the rotation axes 131-133 of the first 3 rotational joints 31-33 associated to the first 3 rigid links 21-23 of kinematic chain 100, intersect each other in a point C positioned, in use, at the centre C′ of the shoulder articulation of the user.

The apparatus 1, furthermore, provides a plurality of actuation groups 70, each of which associated to a respective rotational joint 31-34, and configured to generate and transmit a predetermined driving power to the rotational joint 31-34 associated to it. A detection group 171, 172 is, then, provided configured to determine the angular position of each rotational joint 31-34. As diagrammatically shown in FIG. 3, each actuation group 70 can be, for example, constituted by a motor 71, that can be provided with a safety brake 72, and with a reducer 73. The motor reducer group so obtained is operatively connected through a motor shaft 74 to the joint 31-34 associated to it. The detection group, instead, can comprise an absolute angular sensor 171, in particular an encoder, configured to initialize the system with respect to an absolute reference, and an incremental angular sensor 172 arranged to measure the angular position of the motor shaft 74 once that its initial value has been set by reading the above disclosed absolute angular sensor 171. After the above mentioned initialization, and for all the functioning period of the system, a control unit 350 operatively connected to the rotational joints 31-34, reads the values of both the sensors 171 and 172 of the same rotational joint 31-34, and if the difference between the detected values is greater than a predetermined threshold value, provides to stop the apparatus 1, in a controlled way, because a sensor malfunction could be occurred, and therefore, the necessary safety conditions for the user could be compromised. Therefore, it will not be possible to restart the apparatus before a technical inspection, in order to maintain a high level of safety. It is also provided that the control unit can be arranged to communicate malfunction to the user with visual and/or sound alarms.

Therefore, the actuation groups 70 and the detection groups according to the present invention, not only guarantee to obtain a measurement of the angular position of the different rotational joints that is highly reliable and accurate, but also to work always in extreme safety conditions for the user.

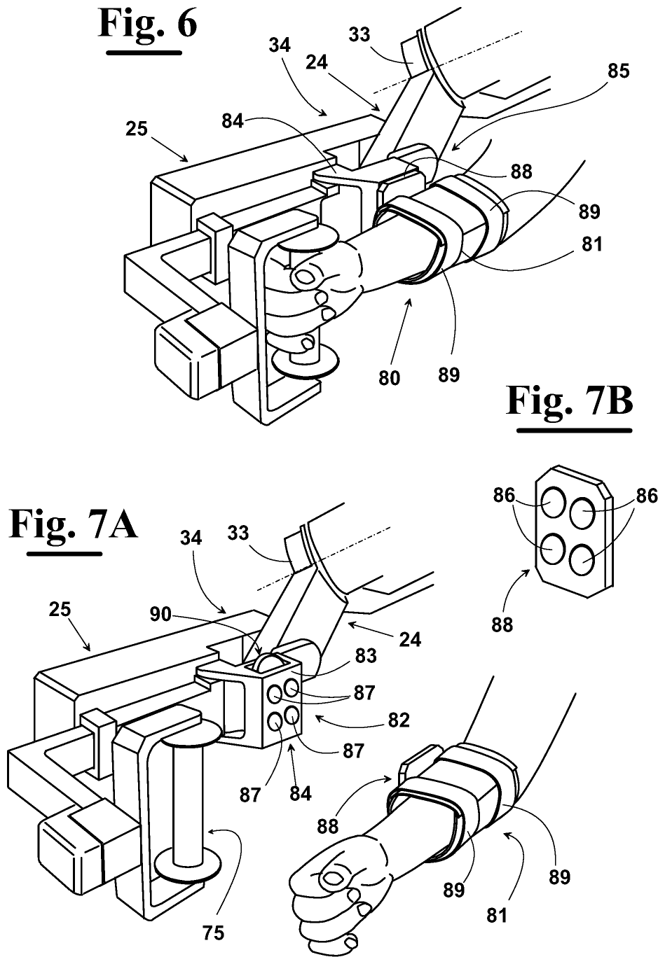

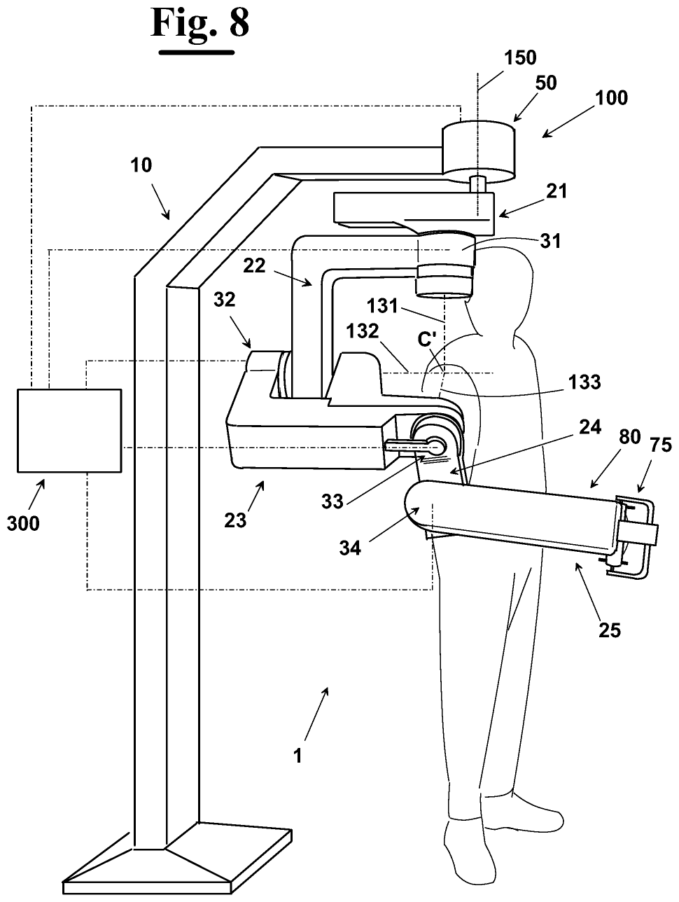

Still as shown in FIG. 1, the apparatus 1 provides a fastening device 80 configured to fasten the user's arm to at least a rigid link of the series, for example the fifth rigid link 25 (see FIGS. 6 and 7A).

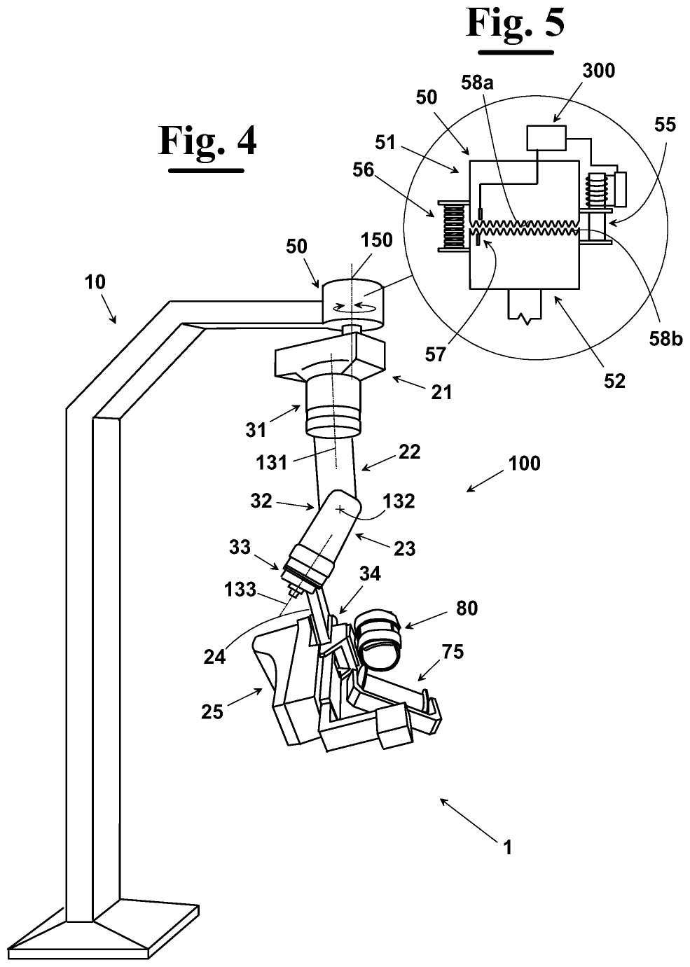

According to a first aspect of the invention, the first rigid link 21 of the series is operatively connected to the base frame 10 through a connection device 50. This is configured to move from a connection configuration (FIGS. 1 and 2), in which the first rigid link 21 is arranged to transmit to the base frame 10 a torque to a release configuration (FIGS. 4 and 5), in which the first rigid link 21 is free to rotate with respect to the base frame 10, for example about a vertical rotation axis 150, whereby it is not anymore able to transmit a torque to the base frame 10, when the connection device 50 is subject to a torque higher than a predetermined threshold value. More precisely, the above disclosed condition occurs when the user exerts a force at the fastening device 80 of the apparatus structure 1 such that at the connection device 50 a torque is produced that is higher than the above mentioned predetermined threshold value. In particular, the torque is transmitted to the connection device 50 through the kinematic chain 100.

The technical solution according to the present invention allows, therefore, to quickly disengage the user from the structure of apparatus 1, in such a way not to hamper the movements, in particular in case the user would have a sudden spasm. Therefore, the present invention allows to increase the safety level for the user, with respect to the prior art solutions.

In particular, as shown in detail in FIGS. 2 and 5, the connection device 50 can comprise a first portion 51 integral to the base frame 10, and a second portion 52 integral to the first rigid link 21. More in particular, when the above disclosed condition occurs and, therefore, the user exerts a force on the apparatus structure 1, at the fastening portion 80, such that the second portion 52 is subjected to a torque higher than a predetermined threshold value, the connection device 50 moves in the above mentioned release configuration and, therefore, the second portion 52 is free to rotate with respect to the first portion 51. Therefore, the whole kinematic chain 100 is connected to the base frame 10 only through a passive joint 50. Therefore, the user is no more constrained, or at least restrained, by the apparatus structure 1, which, therefore, does not oppose the possible movement of the user due, for example, to a sudden muscle spasm that are frequent in patients who do mobility rehabilitation and functional re-education, for example after an ictus.

In the exemplary embodiment diagrammatically shown in FIGS. 2 and 5, the connection device 50 provides, in particular, an electromagnet 55 configured to exert, when supplied with a predetermined direct current and/or voltage, a predetermined magnetic attraction force between the first and the second portion 51 and 52 of the connection device 50. The connection device 50 provides, furthermore, at least an antagonist member, for example an elastic member 56, configured to exert a predetermined antagonist force, for example of elastic type, opposing the above disclosed magnetic attraction force and, therefore, arranged to move the first portion and the second portion 51 and 52 of connection device 50 away one from the other. In working conditions, the magnetic attraction force exceeds the antagonist force by a predetermined value. More precisely, the magnetic attraction force has to be high enough to oppose the antagonist force and the separation force produced at the second portion 52 when this is subjected to a torque. Therefore, when the separation force exceeds a predetermined value, the magnetic attraction force is no more able to oppose the rotation of the second portion 52, which, therefore, freely rotates with respect to portion 51. This rotation is detected by at least a sensor 57, in particular a presence sensor, which sends a corresponding movement signal to a control unit 300, which provides to interrupt the direct current and/or voltage supply to the electromagnet 55. Therefore, since the magnetic attraction force fails, the antagonist force exerted by antagonist member 56 causes the separation of the second portion 52 from the first portion 51, and, therefore, causes, as above anticipated, the disengagement of the kinematic chain 100 from the base frame 10.

According to a possible embodiment, the first and the second portion 51 and 52 of the connection device 50 can provide respective surfaces facing each other 51a and 52a with high friction, which, in the connection configuration of connection device 50, are positioned adjacent one another. Therefore, in this case, the magnetic attraction force will be set in such a way to oppose the forces that would cause the above disclosed rotation of the second portion 52 of connection device 50 with respect to the first portion 51, and, therefore, the sum of elastic force, separation force, and static friction force, that in this case cannot be ignored.

For example, the high friction of the surfaces facing each other 51a and 52a can be obtained by respective teeth 58a and 58b arranged to engage with each other in order to provide a mutual engagement of the first and the second portion 51 and 52 of connection device 50.

The connection device 50 is preferably associated to an adjustment device configured to adjust the above disclosed magnetic attraction force exerted by the electromagnet, in such a way to adjust, accordingly, the predetermined threshold value of torque beyond which the first and the second portion 51 and 52 disengages from each other. For example, the adjustment device can be a potentiometer configured to adjust the direct current and/or voltage supplied to the electromagnet 55. In fact, as can be easily understood, the supplied direct current and/or voltage is proportional to the magnetic attraction force exerted by the electromagnet 55.

In an alternative embodiment of the invention shown in detail in figures from 6 to 7B, the fastening device 80 can be configured to move from an engagement configuration, in which is arranged to engage the user's arm to at least a rigid link of the kinematic chain 100, for example the last rigid link 25 of the kinematic chain 100, to a disengagement configuration, in which the fastening device 80 is arranged to disengage the user's arm from the, or each, rigid link 25. More precisely, the above mentioned movement from the engagement configuration to the disengagement configuration occurs when the force applied by the user at the fastening device 80 is greater than a predetermined force threshold value.

Still as shown in the figures from 6 to 7B, the fastening device 80 can comprise at least a housing portion 81, in particular substantially cradle-shaped, configured to house, in use, the user's forearm, and a fastening portion 82 fixed to the rigid link 25. For example, the user's arm can be engaged to the housing portion 81 by means of one, or more, clamps 89.

More in particular, the fastening device 80 is associated to a safety device 85 configured to mutually engage, in a removable way, the above mentioned housing portion 81 and the fastening portion 82. Furthermore, the safety device 85 can be associated to an adjustment device 90 configured to adjust the predetermined force threshold value beyond which the housing portion 81 disengages from the fastening portion 82.

In the embodiment of FIGS. 7A and 7B, the safety device 85 comprises at least a magnet 86, for example 4 magnets 86 mounted on a support plate 88 fixed to the housing portion 81. More precisely, the magnets 86 are configured to exert a predetermined magnetic force on respective portions 87 of an element made of ferromagnetic material. For example, the different portions 87 can be provided on the same element made of ferromagnetic material “divided” into the above disclosed portions 87 by a shield 83, which provides through holes and that is made on a support member 84 fixed to rigid link 25. In this case, the adjustment device 90 can be advantageously configured to increase, or decrease, the entrefer, that is the distance between the portions made of ferromagnetic material 87, and the support to which the magnets 86 are fixed. For example, the adjustment device 90 can provide a knob, or a different actuation member, acting on which a worker can actuate the above mentioned translation of the support member on which the portions made of ferromagnetic material 87 are mounted, for example by a leadscrew system, or similar mechanisms, along a direction orthogonal to the plane of the plate 88, in order to increase, or decrease the entrefer.

In particular, the apparatus 1 can, furthermore, provide a handle portion 75 at which the user is arranged to handle the kinematic chain 100. More in particular, the handle portion 75 can be a support zone for the user's hand and, therefore, no feedback force would be exerted on the apparatus 1. At this regard, it is opportune to note that the handle portion 75 can be rotatably connected to the kinematic chain 100, in order not to hamper the free movements of the user's wrist during the rehabilitation exercises.

According to a particular embodiment of the invention, the electric supply of the connection device 50 can be independent from the electric supply of the other components of the apparatus 1, because the separation operation is of mechanical type. This technical solution increases the safety of apparatus 1, according to the invention, because allows to avoid that in case of a technical problem on the supply line of the apparatus 1, the efficiency of the connection device 50 can be affected.

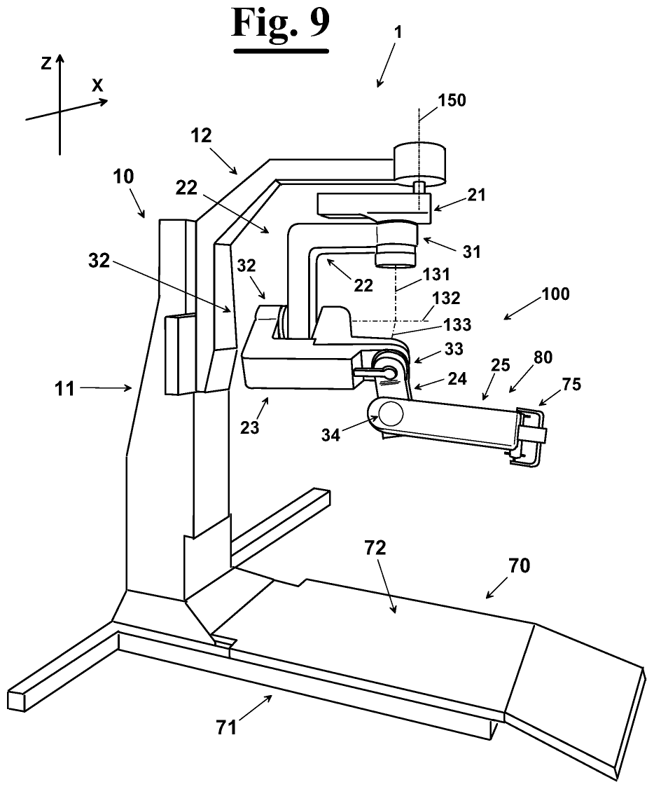

In the embodiment of FIG. 9, the apparatus 1 according to the invention, provides a base member 70. This embodiment is particularly advantageous when the user who does rehabilitation by apparatus 1 is temporarily, or permanently, constrained to a wheelchair.

In particular, the base member 70 can comprise a fixed portion 71 and a movable portion 72 that is able to move from, or towards, a vertical upright 11 with respect to the fixed portion 71. In this way, it is possible to assist the positioning of the user sitting on the wheelchair in the correct position and assuring that this is carried out safely. According to still another embodiment that is diagrammatically shown in FIG. 9, the base frame 10 can be constituted by a single fixed piece, or by several parts integral to each other, in such a way to form a fixed base structure, or can comprise a fixed base portion 11 and a support portion 12 mobile with respect to the fixed base portion 11 along two direction X and Z that are orthogonal to each other. In this case, the movable support portion 12 of frame 10 is connected to the kinematic chain 100 by means of the connection device 50.

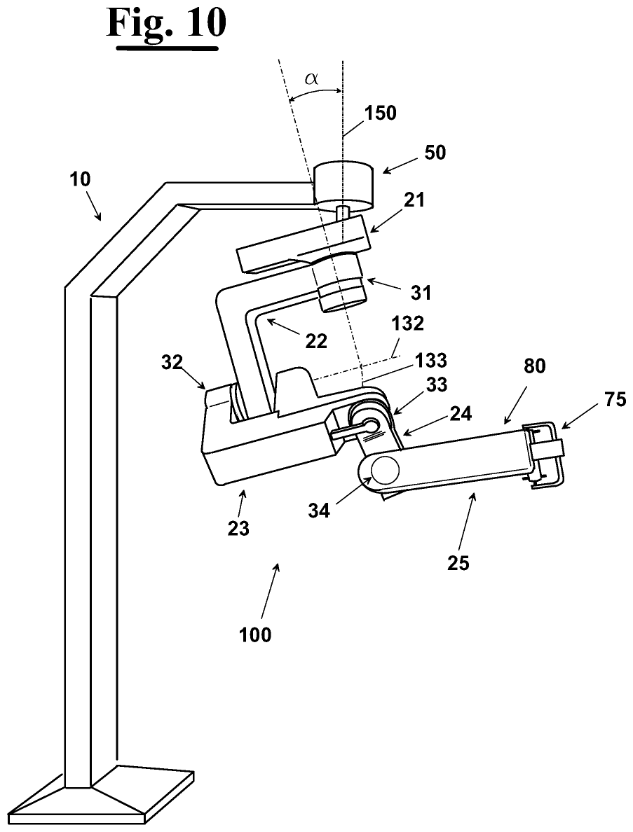

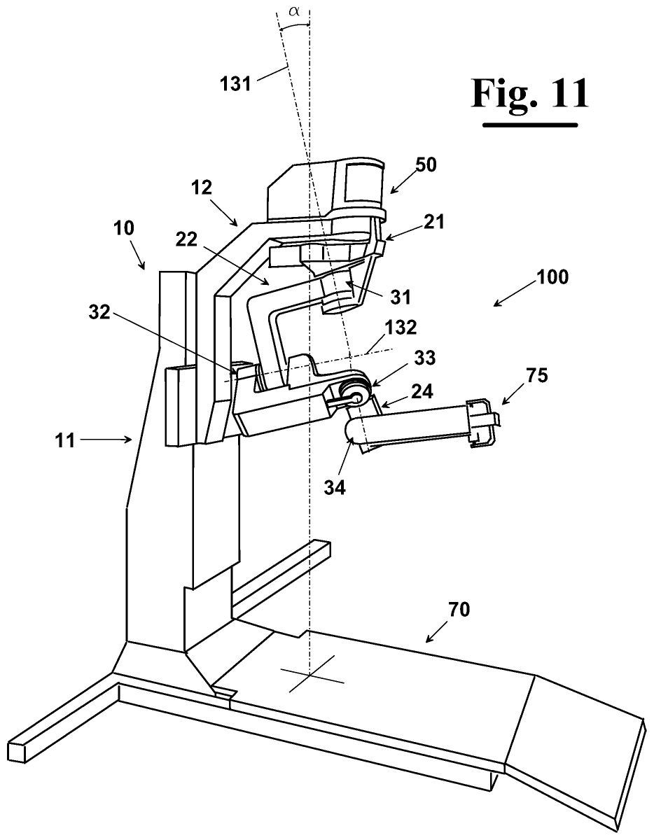

The above mentioned devices, and precisely the connection device 50 and the safety device 85 can be installed on apparatus for rehabilitation 1 of FIGS. 10 and 11. In these embodiments, the rotation axis of the first joint 31 of the kinematic chain 100 is inclined by a predetermined angle α, in particular set between 5° and 30°, with respect to a vertical direction. In this way, the correct positioning of the user with respect to apparatus 1, according to the invention, is easier.

In the embodiment of FIG. 11, apparatus 1 according to the invention, provides both the base member 70 described with reference to the embodiment of FIG. 9 and the inclined axis of FIG. 10. This embodiment is particularly advantageous when the user who does rehabilitation by apparatus 1 is temporarily, or permanently, constrained to a wheelchair.

Furthermore, both safety device 85 and connection device 50 as above described can be installed on apparatus for rehabilitation that are designed to be alternatively configured to do rehabilitation on the user's right arm, or left arm.

The foregoing description exemplary embodiments of the invention will so fully reveal the invention according to the conceptual point of view, so that others, by applying current knowledge, will be able to modify and/or adapt for various applications such embodiment without further research and without parting from the invention, and, accordingly, it is therefore to be understood that such adaptations and modifications will have to be considered as equivalent to the specific embodiments. The means and the materials to realize the different functions described herein could have a different nature without, for this reason, departing from the field of the invention. It is to be understood that the phraseology or terminology that is employed herein is for the purpose of description and not of limitation.

1. Apparatus (1) for rehabilitation of un upper limb of a person, said apparatus (1) comprising:
a base frame (10);
a kinematic chain (100) connected to said base frame (10), said kinematic chain (100) comprising:
a plurality of rigid links (21-25) connected in series one after the other between a first rigid link (21) and a last rigid link (25), said first rigid link (21) being operatively connected to said base frame (10);
a plurality of rotational joints (31-34) each of which having a respective rotation axis (131-134) and arranged to rotatably connect two successive rigid links of said series;
said kinematic chain (100) being configured in such a way that the rotation axes (131-133) of the first 3 rotational joints (31-33) starting from said first rigid link (21) are arranged to intersect each other in a point C positioned, in use, at the centre C′ of the shoulder articulation of the user;
a plurality of actuation groups (70), each actuation group (70) of said plurality being associated to a respective rotational joint and being configured to generate and transmit a predetermined driving power to said rotational joint associated to it;
a detection group (171,172) configured to determine the angular position of each rotational joint of said plurality;
a fastening device (80) configured to fasten the user's arm to at least a rigid link of said plurality;
said apparatus (1) being characterised in that said first rigid link (21) is operatively connected to said base frame (10) by means of a connection device (50) configured to move from a connection configuration, in which is arranged to transmit a torque between said first rigid link (21) and said base frame (10), to a release configuration, in which said first rigid link (21) is free to rotate with respect to said base frame (10) whereby no torque can be transmitted between said first rigid link (21) and said base frame (10), when the user exerts, at said fastening device (80), a force such that the torque transmitted to said connection device (50) is greater than a predetermined threshold value.

2. Apparatus, according to claim 1, wherein said connection device (50) comprises:
a first portion (51) integral to said base frame (10) and a second portion (52) integral to said first rigid link (21), said second portion (52) arranged to rotate with respect to said first portion (51) when subjected to a torque higher than said predetermined threshold value.

3. Apparatus, according to claim 2, wherein said connection device (50) comprises, furthermore:
an electromagnet (55) configured to exert a predetermined magnetic attraction force between said first and said second portion (51,52) when is supplied with a predetermined direct current and/or voltage, said predetermined magnetic attraction force being correlated to said predetermined threshold value;
at least an antagonist member (56) configured to exert a predetermined antagonist force opposing said magnetic attraction force and arranged to move said first portion and said second portion (51,52) of said connection device (50) away from each other.

4. Apparatus, according to claim 3, wherein said connection device (50) comprises, furthermore:
at least a presence sensor (57) configured to detect said relative rotation between said first and said second portion (51,52) and to send a relative control signal to a control unit (300), said control unit (300) arranged to interrupt said direct current and/or voltage supply to said electromagnet when receives said control signal.

5. Apparatus, according to claim 3, wherein said antagonist member is configured to exert a predetermined antagonist elastic force to said magnetic attraction force.

6. Apparatus, according to claim 2, wherein said first and said second portion (51,52) provide respective surfaces facing each other (51a,52a) with high friction, in said connection configuration of said connection device (50) said surfaces facing each other (51a,52a) being arranged adjacent one another.

7. Apparatus, according to claim 6, wherein said surfaces (51a,52a) facing each other provide respective plurality of teeth arranged to engage with each other to mutually engage said first and said second portion (51,52) of said connection device (50).

8. Apparatus, according to claim 3, wherein said connection device (50) is associated to an adjustment device configured to adjust said magnetic attraction force exerted by said electromagnet between said first and said second portion (51,52), in such a way to adjust said predetermined threshold value.

9. Apparatus, according to claim 1, wherein said fastening device (80) is configured to move from an engagement configuration, in which is arranged to engage the user's arm to said, or each, rigid link of said plurality, to a disengagement configuration, in which is arranged to disengage said arm of said user from said, or each, rigid link of said plurality, when the force applied by the user at said fastening device (80) is greater than a predetermined force threshold value.

10. Apparatus, according to claim 9, wherein said fastening device (80) comprises:
at least a housing portion (81) configured to house, in use, the user's forearm;
a fastening portion (82) fixed to said, or each, rigid link;
said fastening device (80) being, furthermore, associated to a safety device (85) configured to mutually engage, in a removable way, said housing portion (81) and said fastening portion (82).

11. Apparatus, according to claim 10, wherein said safety device (85) is associated to an adjustment device (90) configured to adjust said predetermined force threshold value.

12. Apparatus, according to claim 10, wherein said safety device (85) comprises at least a magnet (86) integral a said housing portion (81), or a said fastening portion (82), said, or each, magnet (86) being configured to exert a predetermined magnetic force on a respective portion made of ferromagnetic material (87) integral, respectively, to said fastening portion (82), or a said housing portion (81).

13. Apparatus, according to claim 12, wherein said adjustment device (90) is configured to increase, or decrease, the entrefer, which is the distance between said portion made of ferromagnetic material and said, or each, magnet.

14. Apparatus, according to claim 1, wherein said base frame (10) and said kinematic chain (100) are configured in such a way that the rotation axis (131) of the first rotational joint (31) of said kinematic chain (100) is inclined by a predetermined angle α with respect to a vertical direction, in such a way to simplify the positioning of the centre C′ of the shoulder articulation of the user at said intersection point C of said first 3 rotation axes (131-133).

15. Apparatus, according to claim 1, wherein said base frame (10) comprises:
an upright (11);
a base member (70) having a fixed portion (71) and a movable portion (72), said movable portion (72) being configured to slide with respect to said fixed portion (71) da/verso said upright (11), said rotation axis (131) of said first rotational joint (31) of said kinematic chain (100) being inclined of said predetermined angle a with respect to a direction orthogonal to said base member (70).

16. Apparatus (1), according to claim 14, wherein said angle α is set between 5° and 30°.

17. Apparatus (1), according to claim 1, wherein said base frame (10) comprises a fixed base portion (11) and a support portion (12) slidingly mounted on said fixed base portion (11) along a first and a second sliding direction (X,Z) orthogonal to each other, said kinematic chain (100) being mounted on said support portion (15).

18. Apparatus (1) for rehabilitation of an upper limb of a person, said apparatus (1) comprising:
a base frame (10);
a kinematic chain (100) connected to said base frame (10), said kinematic chain (100) comprising:
a plurality of rigid links (21-25) connected in series one after the other;
a plurality of rotational joints (31-34) each of which having a respective rotation axis (131-134) and arranged to rotatably connect two successive rigid links of said series;
said kinematic chain (100) being configured in such a way that the rotation axes (131-133) of the first 3 rotational joints (31-33) are arranged to intersect each other in a point C positioned, in use, at the centre C′ of the shoulder articulation of the user;
a plurality of actuation groups (70), each actuation group of said plurality being associated to a respective rotational joint and be configured to generate and transmit a predetermined driving power a said rotational joint associated to it;
a detection group (171,172) configured to determine the angular position of each rotational joint of said plurality;
a fastening device (80) configured to fasten the user's arm to at least a rigid link of said plurality;
said apparatus (1) being characterised in that said base frame (10) and said kinematic chain (100) are configured in such a way that the rotation axis (131) of the first rotational joint (31) of said kinematic chain (100) is inclined by a predetermined angle α with respect to the vertical direction, in such a way to simplify the positioning of the centre C′ of the shoulder articulation of the user at said intersection point C of said first 3 rotation axes (131-133).

19. Apparatus (1) for rehabilitation of an upper limb of a person, said apparatus (1) comprising:
a base frame (10);
a kinematic chain (100) connected to said base frame (10), said kinematic chain (100) comprising:
a plurality of rigid links (21-25) connected in series one after the other between a first rigid link (21) and a last rigid link (25), said first rigid link (21) being operatively connected to said base frame (10);
a plurality of rotational joints (31-34) each of which having a respective rotation axis (131-134) and arranged to rotatably connect two successive rigid links of said series;
said kinematic chain (100) being configured in such a way that the rotation axes (131-133) of the 3 rotational joints (31-33) starting from said first rigid link (21) are arranged to intersect each other in a point C positioned, in use, at the centre C′ of the shoulder articulation of the user;
a plurality of actuation groups (70), each actuation group (70) of said plurality being associated to a respective rotational joint and being configured to generate and transmit a predetermined driving power to said rotational joint associated to it;
a detection group (171,172) configured to determine the angular position of each rotational joint of said plurality;
a fastening device (80) configured to engage the user's arm to at least a rigid link of said plurality;
said apparatus (1) being characterised in that the fastening device (80) is configured to move from an engagement configuration, in which is arranged to engage the user's arm to said, or each, rigid link of said plurality, to a disengagement configuration, in which said user's arm is engaged to said, or each, rigid link of said plurality, when the force applied by the user at said fastening device (80) is greater than a predetermined force threshold value.
